(19) United States
(12) Patent Application Publication
(10) Pub. No.: US 2018/0187820 A1
(43) Pub. Date: Jul. 5, 2018

(54) PERMEABLE LINER

(71) Applicant: Dow Global Technologies LLC, Midland, MI (US)

(72) Inventors: Fabio Aguirre Vargas, Lake Jackson, TX (US); John Klier, Leverett, MA (US); William A. Koonce, Pearland, TX (US); Juan Carlos Medina, Lake Jackson, TX (US); Nathan Wilmot, Missouri City, TX (US); Kaoru Aou, Lake Jackson, TX (US); Sachit Goyal, Houston, TX (US)

(21) Appl. No.: 15/740,400

(22) PCT Filed: Jun. 21, 2016
(86) PCT No.: PCT/US2016/038481

§ 371 Date: Dec. 28, 2017

Related U.S. Application Data
(60) Provisional application No. 62/186,671, filed on Jun. 30, 2015.
(60) Provisional application No. 61/286,669, filed on Dec. 15, 2009.
(60) Provisional application No. 62/186,645, filed on Jun. 30, 2015.

(51) Int. Cl. F16L 58/10; C09D 5/00; C09K 8/536; C09K 8/524

(52) U.S. Cl. CPC F16L 58/1027; C09D 5/00; E21B 21/063; C09K 8/524; C09K 8/536

(57) ABSTRACT

A contaminant capturing liner includes a cured product of a composition including an epoxy resin component including at least one alkanolamine modified epoxy resin and at least one hardener. The contaminant capturing liner includes at least one contaminant capturing material embedded therewithin, and the contaminant capturing liner is a permeable layer having a difference between dry glass transition temperature and wet glass transition temperature of at least 14 C.

### FIELD

Embodiments relate to a curable composition for making a powder coating material, a powder coating material made from the curable composition, and a liner (also referred to as a coating) made from the powder coating material. The liner can be formed on or attached to the surface of a substrate such as the interior surface of a pipeline, pipe, piping, tube, tubing or other cylindrical member; and then the coated pipeline can be useful for removing and/or capturing contaminants such as radionuclide and/or sulfides from liquids passing through the interior passageway of the pipeline and contacting the liner.

### INTRODUCTION

The oil and gas industry has continuously had to deal with the issue of contaminants being present in oil and gas liquids produced from downhole reservoirs. For example, the wastewater recovered from the reservoirs may be pumped to a treatment facility to remove or reduce undesirable products or unwanted contaminants (e.g., radionuclides, H₂S, and CO₂). It would be desirous to be able to remove the unwanted contaminants from the wastewater before it reaches the treatment facility. The removal of the undesirable products from wastewater before reaching treatment facilities will reduce the generation of hazardous waste and reduce the cost of purifying crude wastewater.

Heretofore, various methods and pipe structures have been proposed for removing contaminants from the fluids flowing through the center passageway of pipe structures. Proposed methods for removing contaminants are commonly based on coatings applied to the inner surface of a pipe substrate for traditional piping applications. For example, U.S. Pat. Nos. 8,726,989 and 8,746,335 disclose a method for removing contaminants from wastewater in a hydraulic fracturing process. The above patents discuss removal of contaminants during a hydraulic fracturing process utilizing a pipe coating. The pipe coating includes a contaminant-capturing substance for capturing the contaminants such as toxic and radioactive materials from the wastewater as the wastewater flows through the pipe. The coating in the pipe captures and sequesters the contaminants in the coating. However, the above proposed processes disclosed in U.S. Pat. Nos. 8,726,989 and 8,746,335 do not disclose the composition of the coating, the application method, and the nature of the contaminant-capturing substance.

### SUMMARY

Embodiments may be realized by providing a contaminant capturing liner that includes a cured product of a composition including an epoxy resin component including at least one alkanolamine modified epoxy resin and at least one hardener. The contaminant capturing liner includes at least one contaminant capturing material embedded therewithin, and the contaminant capturing liner is a permeable layer having a difference between dry glass transition temperature and wet glass transition temperature of at least 14° C.

### BRIEF DESCRIPTION OF THE DRAWINGS

For the purpose of illustrating exemplary embodiments, the drawings are provided. However, it should be understood that embodiments are not limited to the precise arrangements and instrumentation shown in the drawings. In the drawings, like elements are referenced with like numerals.

FIG. 1 is a schematic cross-sectional view of layers of a pipe structure including a permeable liner layer according to an exemplary embodiment.

FIG. 2 is a micrograph image (at 10× magnification) showing cross-sectional view of layers of a pipe structure including a permeable liner layer bonded to a steel pipe substrate, according to an exemplary embodiment.

FIG. 3 is a schematic cross-sectional view of layers of a pipe structure including a permeable liner layer according to an exemplary embodiment.

FIG. 4 is a schematic cross-sectional view showing a cross-sectional portion of a multi-layer a pipe structure including a permeable liner layer and a steel pipe substrate, according to an exemplary embodiment.

FIG. 5 is a schematic cross-sectional view of a multi-layer pipe structure including a permeable liner layer after removing the gloss layer, according to an exemplary embodiment.

### DETAILED DESCRIPTION

“Permeable” herein, with reference to a cured polymeric liner/coating, means that an unwanted contaminants (for example radionuclides, H₂S and CO₂) present in a liquid such as water, can penetrate into the polymeric liner/coating. The permeability of the liner can be determined by measuring the glass transition temperature (Tg) of the liner, before and after wetting the liner with deionized water and correlating the Tg measurements to permeability. A reduction in the liner Tg would indicate water has penetrated the liner bringing the contaminant in contact with the contaminant-removing particulate compound inside the polymeric liner. We surprisingly found an increase in the range between dry and wet glass transition temperature of the cured polymeric liner/coating, when using an alkanolamine modified solid epoxy resins, which resulted in greater removal of contaminants. Upon removing the water from the liner, the resulting Tg should be substantially the same as the initial Tg of the liner before wetting the liner. This would indicate that water diffusion and the water's plasticization effect on the polymer is the primary driver for liner permeability and not, for instance, the hydrolysis or saponification of the polymeric liner, which would be undesirable since the polymer network would be compromised releasing the radionuclide removal compound into the aqueous media. For the purpose herein we will use the range between dry and wet Tg as a measure of liner permeability. Embodiments related to a permeable linear that is able to achieve of difference between dry and wet Tg of at least 10° C., at least 14° C., at least 15° C., and/or at least 16° C. The difference between dry and wet Tg may be less than 50° C., less than 40° C., less than 30° C., less than 25° C., and/or less than 20° C.

Another way to measure the liner permeability is using Electrochemical Impedance Spectroscopy (EIS), measures the dielectric properties of a medium as a function of frequency. The Bode Plot obtained by EIS displays absolute value of impedance (log |Z|/ohms) versus frequency (log f/Hz). High impedance, for instance >10⁸ ohms, at given frequency, for instance 10⁻¹ Hz, after one day exposure to a brine solution at for instance 90° C. is due to the coating resistance to water permeability, which is fundamental characteristic of coatings used for corrosion protection. However, since the coating composition makes the polymer permeable it is expected to have impedance values <10⁸ at, for instance 10⁻¹ Hz, after one day exposure to a brine solution at for instance 90° C. Another way to measure liner permeability is by measuring the weight of the liner before and after exposing it to water at for instance 90° C. for at least 24 hours. A weight gain of >1% of the liner and by observing that no insoluble particle of the radionuclide removal compound are particles of the radionuclide or sulfide removal compound are released into the aqueous media would indicate water absorption by the permeable liner. For the purpose of this invention we will use the range between dry and wet Tg as a measure of liner permeability.

“Radionuclide” herein means radioactive nuclide or a nuclide that is radioactive such as for example radium-226 (or ²²⁶Ra).

“Radionuclide removal” herein means a process for removing or capturing radionuclide by using contaminant-capturing compounds such a BaSO₄.

Embodiments are directed to a permeable curable epoxy thermoset composition capable of removing and/or capturing contaminants, such as radionuclides, H₂S, and/or CO₂, for example from an aqueous medium. In a broad scope, a permeable polymeric liner/coating may be attached to the inner surface of cylindrical articles such as tubes or pipelines; and the cylindrical articles containing the liner is adapted for removing radionuclide contaminants from liquids, such as an aqueous medium, passing through the interior passageway of the cylindrical articles. Metal ions, such as divalent radium, are removed from the aqueous medium when the aqueous medium contacts the thermoset epoxy composition containing a water-insoluble compound such as barium sulfate.

Exemplary embodiments are directed to a curable composition for making a liner/coating (e.g., powder coating) including (a) at least one epoxy resin, e.g., at least one alkanolamine modified epoxy resin; (b) at least one curing agent or hardener; and (c) at least one contaminant-capturing material in a predetermined amount for capturing contaminants. Exemplary embodiments may be directed to a powder coating material made from the above curable composition, wherein the powder is useful for making a coating and/or liner with a broader range between dry and wet glass transition temperatures. Exemplary embodiments may be directed to a coating material made from the above curable composition, wherein the liner/coating is useful for capturing and/or removing contaminants. Exemplary embodiments may be directed to a pipe substrate having the above permeable liner or permeable polymer coating attached to the interior surface of the pipe. Exemplary embodiments may be directed to a process for manufacturing said permeable liner or coating and the removal of the glossy layer of the permeable liner or coating, the pipe with the sanded coating being useful for capturing contaminants from a liquid or gas passing through the interior of the pipe. Exemplary embodiments may be directed to a process for removing contaminants from a liquid or gas contacting the above permeable liner/coating which is attached to a pipe substrate by capturing contaminants from the liquid passing through the interior of the pipe in the above permeable liner/coating.

The permeable polymeric liner can be modified to adsorb or capture unwanted contaminants (such as radionuclides, H₂S and CO₂), for example, the permeable polymeric liner, made from a thermosetting polymer such as an epoxy, can be modified to including a sufficient amount of a (c) at least one contaminant-capturing material such as BaSO₄, ZnO in a predetermined amount for capturing contaminants (e.g., at least about 20%). The (c) contaminant-capturing particulate material is useful for absorbing, scavenging, or sequestering the undesired contaminants from a liquid or gas containing such contaminants. The permeable polymeric liner of the present invention advantageously can be applied inside downhole tubes and/or pipelines.

For example, embodiments may include a permeable liner composite article, e.g., for radionuclide and sulfides removal/capture. The permeable liner composite article of the present invention uses (c) contaminant-capturing particulate material in the liner structure. For example, the liner utilizes a contaminant removal material embedded within the permeable liner structure. The incorporated filler, such as barium sulfate or zinc oxide, is the means for capturing contaminants. The liner is attached to the inner surface of a substrate such a tube or a pipe. For example, once the liner is attached to the pipe and the gloss layer is removed, the pipe with the liner is then ready for service.

An exemplary embodiment includes a process of manufacturing the above permeable liner useful for contaminant removal and/or capturing. In general the process includes the steps of: (1) preparing a curable powder coating composition comprising at least the following components: (a) at least one epoxy resin (component), including at least one alkanolamine modified curable epoxy resin; (b) at least one curing agent or hardener; (c) at least one contaminant-capturing material comprising at least one filler material embedded in the polymer resin, wherein the at least one filler material is adapted for removing contaminants (for example radionuclides, H₂S and CO₂) from a liquid or gas fluid in intimate contact with the filler material (2) attaching, adhering or bonding the curable composition of step (1) onto the surface of a substrate such as a pipe member to form a permeable liner bonded to the substrate and (3) optionally, removing the gloss layer of the permeable liner. Step (2) can include processing the above curable composition to form a permeable liner/coating on the substrate by reacting/curing the composition of step (1).

Depending on the type of epoxy resin and hardener used, the curable composition can be applied in a powder or liquid form to a metal substrate (for instance tubes, pipelines, tanks secondary containment used for extraction, transportation and storage of wastewater and crude oil) or a metal substrate coated with a primer. The curable composition can also be applied to composite and proppants applications.

In an exemplary embodiment, the permeable curable epoxy thermoset composition may be used to remove/capture contaminants (for example radionuclides, H₂S, and CO₂) from wastewater which is extracted during oil recovery eliminating or at least reducing the need for further water treatment. The curable epoxy thermoset composition containing the captured contaminants remains underground attached to the coated pipe.

In an exemplary embodiment, the dry glass transition temperature (Tg) of the curable epoxy composition can be at least 15° C. above the wet Tg. Without binding to any theory, it is believed that in this dry and wet Tg range water of the aqueous medium substantially permeates the polymer network enabling the removal of contaminants by filler material embedded in the polymer resin.

Preparation of the permeable liner may begin with preparing a curable composition for making a curable powder coating material that, in turn, is eventually processed to form the liner. In one embodiment, the curable powder coating composition includes: (a) at least one alkanolamine modified epoxy resin, and optionally at least one other epoxy resin; (b) at least one hardener; (c) at least one contaminant-capturing material, wherein the amount of the contaminant-capturing material is greater than 25 percent by weight. To make the curable powder coating composition containing a radionuclide or sulfide removal mechanism includes, e.g., admixing the above compounds or components and any optional components at a temperature and time sufficient to prepare an effective curable composition.

The above curable composition can also include optional materials such as for example a flow aid, leveling aid, and dispersing aid at a concentration of from about 0.2 wt. % to about 2 wt. %. For example, such aids can include acrylic-based copolymer like Modaflow powder III available from Cytec; Resiflow PF67 available from Estron Chemical; and BYK-360 P, available from BYK Chemie, a wax-based powdered processing additive with pigment-affinic groups for powder coatings such as BYK-3950 P, BYK-3951 P from BYK-Chemie GmbH useful for improving pigment and filler dispersion and processing) to homogeneously disperse the above components, particularly the above particulate material. The curable composition may also optionally include an accelerator including, but are not limited to, imidazoles, anhydrides, polyamides, aliphatic amines, epoxy resin-amine adducts, and tertiary amines An accelerator may be present in the coating composition at a concentration of from about 0.1 wt. % to about 3 wt. %. An example of a suitable commercially available accelerator includes, but is not limited to, EPI-CURE Curing Agent P101, available from Hexion Specialty Chemicals or 2-methyl imidazole available from Sigma-Aldrich.

The polymeric liner composition includes for example, a polymeric resin such as, but is not limited to, for example epoxy, phenolic, polyurethane, polyurea, hybrids, vinyl ester, silicones and polyesters and the like, preferably an epoxy resin such as a solid epoxy resin (SER) or an epoxy resin such as a liquid epoxy resin (LER).

The curable epoxy composition can be applied in powder form inside the downhole tube or pipeline using equipment known to those skilled in the art to form the permeable liner of the present invention. The curable epoxy composition can be applied directly to metal (DTM), over a primer, or over a mid-coat. The curable epoxy composition can be applied at room temperature (about 25° C.) and then baked at a temperature of for example from about 120° C. to about 240° C. In other embodiments, the bake temperature can be about greater than or equal to 120° C., greater than or equal to 150° C., greater than or equal to 200° C., and greater than or equal to 240° C. The permeable polymer can also be applied as a powder on a tube or pipe which has been preheated to a temperature of from about 150° C. to about 240° C. In other embodiments, the preheat temperature can be greater than or equal to about 150° C., greater than or equal to 200° C., and greater than or equal to 240° C. to form the permeable liner.

In another embodiment, removing the gloss layer of the permeable liner of the present invention can be achieved by using Brush-off Blast Cleaning (a.k.a. Sweep blasting). In one embodiment, the curable epoxy composition can be first dissolved in for instance xylene or other suitable solvents or combination thereof; and then be applied in liquid form inside the downhole tube or pipeline using equipment and a curing schedule known to those skilled in the art to form the permeable liner. The process for formulating the polymeric liner composition may be a batch process, an intermittent process, or a continuous process using equipment well known to those skilled in the art.

The polymeric resin (epoxy component) may include at least one alkanolamine modified epoxy resin, component (a), to form a polymeric liner. For example, the alkanolamine modified epoxy resin can be a liquid of solid epoxy resin.

For example, the alkanolamine material useful in the process may include, e.g., one or more alkanol amines the alkanolamines such as diethanolamines, ethanolamines, 2-amino-1-butanol, 2-amino-2-methyl-1-propanols, 2-amino-2-ethyl-1,3-propanediols, tris(hydroxymethyl)aminomethanes, 2-amino-2-methyl-1,3-propanediols, monomethylaminoethanols, isopropylaminoethanols, t-butylaminoethanols, ethylaminoethanols, n-butylaminoethanols, isopropanolamines, diisopropanolamines, diethanolamines, tris(hydroxymethyl)aminomethanes. In another exemplary embodiment, the alkanolamines are tris(hydroxymethyl)aminomethanes.

For example, tris(hydroxymethyl)aminomethane (THAM) modified epoxy resin can be used in the curable epoxy composition of the present invention to increase the range between dry and wet glass transition temperature.

Alkanolamines that can also be used as curing agents or hardeners in FBE coatings to increase the range between dry and wet glass transition temperature. For example, the tris(hydroxymethyl)aminomethanes are marketed under the name TRIS AMINO by The ANGUS Chemical Company; the diethanolamines are marketed under the name diethanolamine by Aldrich Chemical Co., Inc.; the 2-amino-2-methyl-1,3-propanediols are marketed under the name AMPD™ by ANGUS Chemical Company; the 2-amino-1-butanols are marketed under the name AB by ANGUS Chemical Company; the 2-amino-2-methyl-1-propanols are marketed under the name AMP by ANGUS Chemical Company; and the 2-amino-2-ethyl-1,3-propanediols are marketed under the name AEPD by ANGUS Chemical Company. THAM epoxy adducts can also be used in the curable epoxy composition of the present invention, to increase the range between dry and wet glass transition temperature.

The concentration of the alkanolamine modified epoxy resin used in the curable composition may range from about 10 wt % to about 60 wt % in one embodiment, from about 20 wt % to about 50 wt % in another embodiment, and from about 25 wt % to about 40 wt % in still another embodiment. Without intending to be bound by this theory, if there is too little of the alkanolamine modified solid epoxy resin in the gel layer, there may not be sufficient material to allow water to permeate the coating and increase the range between dry and wet glass transition temperature. If there is too much alkanolamine modified solid epoxy resin in the gel layer, there may not be sufficient contaminant-capturing particulate material to remove the contaminant of interest.

Any epoxy resin, including blends of liquid and solid epoxy resins, that is solid at room temperature (i.e., about 25° C.) may be used in the curable composition. Exemplary embodiments include at least one alkanolamine modified epoxy resin (a) comprising a solid epoxy resin containing for instance from 0.5 to 2.0% tris(hydroxymethyl)aminomethane (THAM) in an epoxy resin from a 1.5-type to a 10-type epoxy resin in one embodiment. The epoxy resin may be, e.g., a 2-type to a 9-type solid epoxy resin in an embodiment; and the epoxy resin may be, e.g., a 2-type to a 7-type solid epoxy resin in still an embodiment, as defined by Pham, H. Q.; Marks, M. J., Epoxy Resins in Ullmann's Encyclopedia of Industrial Chemistry; Wiley-VCH: Weinheim, 2005; and commercially available from Olin Epoxy, a division Olin Corporation, under its D.E.R 600 series epoxy resins. In addition, any epoxy-terminated resin including, but not limited to, “Taffy” epoxy resins; bisphenol F based solid epoxy resins; brominated solid epoxy resins; and oxazolidinone and isocyanurate based epoxy-resins can be utilized in place of or in combination with the DER 600 series epoxy resins. Further, solid and liquid epoxy-functionalized novolacs can also be utilized in the curable composition. The novolacs may be used alone or blended with one or more other solid epoxy-terminated resins.

Other epoxy resins that can be used in the curable composition (e.g., in combination with alkanolamine modified solid epoxy resin) can include, e.g., D.E.R. 662-E, D.E.R. 663-UE, D.E.R. 664-UE, D.E.R. 664-U, D.E.R. 664-HA, D.E.R. 664U-20, D.E.R. 642U, D.E.R. 642U-20, D.E.R. 672U, D.E.R. 672U-20 epoxy resins commercially available from Olin Epoxy; and mixtures thereof.

A total amount of epoxy resins (including the alkanolamine modified epoxy resin) in the curable composition may range from about 10 wt % to about 60 wt. % in one embodiment, from about 20 wt % to about 50 wt % in another embodiment, and from about 25 wt. % to about 45 wt. % in still another embodiment.

The curable coating composition includes a curing agent or hardener as component (b). The hardener can be any conventional curing agent used to cure a thermosetting resin. For example, the hardener may include a phenolic or amine hardener for curing the alkanolamine modified epoxy resin. In an exemplary embodiment, the curing agent may include, e.g., one or more aliphatic amines, cycloaliphatic amines, polyetheramines, and mixtures thereof.

Non-limiting examples of suitable curing agents include, but are not limited to, amine-curing agents such as dicyandiamide, diaminodiphenylmethane and diaminodiphenylsulfone, polyamides, polyaminoamides, polymeric thiols, polycarboxylic acids and anhydrides such as phthalic anhydride, tetrahydrophthalic anhydride (THPA), methyl tetrahydrophthalic anhydride (MTHPA), hexahydrophthalic anhydride (HHPA), methyl hexahydrophthalic anhydride (MHHPA), nadic methyl anhydride (NMA), polyazealic polyanhydride, succinic anhydride, maleic anhydride and styrene-maleic anhydride copolymers, as well as phenolic curing agents such as phenol novolac resins; and mixtures thereof.

Examples of suitable commercially available hardeners or curatives are described in, e.g., WO2010096345A1. Examples may include Dicyandiamid AB 04, available from Degussa Corporation; XZ 92769.01, D.E.H 80, 82, 85 and D.E.H 87 Epoxy Curing Agent, available from Olin Corporation; Amicure CG, Amicure CG-NA, Amicure CG-325, Amicure CG- 1200, Amicure CG- 1400, Dicyanex 200-X, Dicyanex 325, and Dicyanex 1200, available from Air Products and Chemicals, Inc.; Dyhard 10OM, available from AlzChem LLC; and Aradur 3082, 9664-1, and 9690 available from Huntsman Advanced Materials.

The concentration of the hardener for the curable powder coatings used in the curable composition may range from about 10 wt % to about 20 wt % in one embodiment, from about 7.5 wt % to about 15 wt % in another embodiment, and from about 0.5 wt % to about 10% wt % in still another embodiment.

Permeable linings of the present invention contain (c) at least one contaminant-capturing material, which can contain a metal similar to the specific radionuclide ion to be removed from the aqueous medium. As described in EP 0071810 B1, incorporated herein by reference, a metal is similar to the specific radionuclide ion to be removed from the aqueous medium if the metal will form a water-insoluble compound capable of removing the specific radionuclide ion from aqueous solution and retain the specific metal ion during continued contact with the aqueous medium. Preferably, the similar metal is chemically similar to the specific metal, as predicted by the Periodic Table of elements. Illustratively, the similar metal may be in the same group of the Periodic Table of elements as the specific radionuclide ion, most preferably from a period adjacent to the period of the specific radionuclide ion. In the case of the transition and inner transition metals, the similar metal may be the element adjacent to or nearby the specified metal in the same period of the Periodic Table of elements. For example, where radium is the specific radionuclide ion, the similar metal is barium in one preferred embodiment, however, strontium and calcium may also be used. Therefore, the water-insoluble compounds in the form of a particulate material, component (c), added to the polymer resin composition to form a permeable polymeric liner can include, for example, BaSO₄ and mixtures containing BaSO₄.

In an exemplary embodiment, the particulate material may include, e.g., one or more forms, shapes or sizes of barium sulfate (BaSO₄). One of the beneficial properties of the particulate material includes the capability of the particulate material to capture and entrap a radionuclide by the radionuclide coming into direct contact with the particulate material. Barium sulfate particle size may impact the radium removal rate. Therefore, the size of the barium sulfate particles can be from about 1.0 micron to about 9 microns in one general embodiment. Other embodiments of the size of the barium sulfate particles can include various ranges such as from about 6.5 microns to about 9 microns in one embodiment, from about 3.2 microns to about 6.5 microns in another embodiment, and from about 1.0 micron to about 3.2 microns.

The concentration of the particulate material may range from about 5 wt % to about 90 wt % in one embodiment, from about 15 wt % to about 85 wt % in another embodiment, from about 25 wt % to about 80 wt % in still another embodiment, from about 45 wt% to about 65 wt% in still another embodiment. Without intended to be bound by this theory, if there is too little particulate material in the gel layer, there may not be sufficient material to capture the contaminant of interest. If there is too much particulate material in the gel layer, inter-layer and intra-layer bonding may not be sufficient to form a homogenous article.

The concentration of the particulate material may find advantageous the use of toughening agents and/or flexibilizers to maintain the impact resistance and flexibility of the coatings. Examples of toughening agents and flexibilizers are amphiphilic block copolymers (e.g., FORTEGRA 100, and FORTEGRA 104, available from Olin Corporation), carboxyl-terminated butadiene-acrylonitrile elastomer like FORTEGRA 201 available from Olin Corporation; Ethoflex ER, available from Ethox Chemicals, LLC; B-Tough A and B-Tough C available from Croda; Urethane acrylates like VORASPEC™ 58 or VORASPEC™ 100 available from The Dow Chemical Company.

The curable coating composition may further include a hydrophilic material as component. For example, the hydrophilic material can be any alkanolamine or an alkanolamine modified liquid of solid modified solid epoxy resins, an urethane acrylate, block copolymer or a hydrophilic isocyanate prepolymer. For example, the hydrophilic material may include an alkanolamine hardener for curing the epoxy resin or an alkanol amine-modified epoxy resin. The hydrophilic material useful in the process may include, e.g., one or more alkanol amines the alkanolamines such as diethanolamines, ethanolamines, 2-amino-1-butanol, 2-amino-2-methyl-1-propanols, 2-amino-2-ethyl-1,3-propanediols, tris(hydroxymethyl)aminomethanes, 2-amino-2-methyl-1,3-propanediols, monomethylaminoethanols, isopropylaminoethanols, t-butylaminoethanols, ethylaminoethanols, n-butylaminoethanols, isopropanolamines, diisopropanolamines, diethanolamines, tris(hydroxymethyl)aminomethanes. In another preferred embodiment, the alkanolamines are tris(hydroxymethyl)aminomethanes.

The coating compositions may be pigmented/filled with other additives including pigments, which may be organic or inorganic, e.g., titanium dioxide or hollow core or void containing polymer pigments, and color, for example, iron oxides, micas, aluminum flakes and glass flakes, silica pigments, or organic pigments, such as phthalocyanines, and corrosion protection, for example zinc, phosphates, molybdates, chromates, vanadates, cerates, in addition to durability and hardness such as silicates. Generally, when pigments are included in the coating compositions, the weight ratio of pigment to the total solid of epoxy resin and hardener may range from about 0.1:1 to about 5:1 in one embodiment and from about 0.1:1 up to about 2:1 in another embodiment.

The coating compositions may include other conventional additives in conventional amounts, including, e.g., solvents, rheology modifiers, dispersants, silicones or wetting agents, adhesion promoters, or flow and leveling agents.

The concentration of the optional additives used the coating compositions may range from 0 wt. % to about 5 wt. %, from about 0.1 wt. % to about 3 wt. %, and/or from about 0.5 wt % to about 1 wt %. Below the recommended range the liner might not form a good films and above the recommended range would limit the amount of the contaminant-capturing particulate material that can be added to the permeable liner.

In general, the process for manufacturing the permeable liner useful for radionuclide or sulfide removal includes the steps of: (I) providing a curable composition comprising at least the following components: (a) at least one alkanolamine modified epoxy resin; (b) at least one curing agent or hardener; and (c) at least one contaminant-capturing material comprising at least one filler material embedded in the polymer resin; wherein the filler material is adapted for removing radionuclide and/or sulfides contaminants from a liquid fluid in intimate contact with the filler material; (II) applying the curable composition of step (I) onto the surface of a substrate such as a pipe member; (III) bonding the curable composition of step (I) onto the surface of the substrate to form a permeable liner bonded to the substrate and (IV) removing the gloss layer of the a permeable liner. For example, the composition can be cured by heating such that compounds in the curable powder coating composition react to form a cured polymer matrix embedded with contaminant-capturing material therein.

For example, the first step (I) of the process includes admixing the required components to make the curable powder coating composition such as for example: (i) an alkanolamine modified epoxy resin, (ii) a curing agent such as an amine or phenolic hardener for curing the epoxy resin, (iii) a contaminant-capturing particulate material such as BaSO₄ or ZnO crystals or particles; and any other optional additives desired.

Then the mixture can be processed under conditions for forming a permeable liner/coating including curing the above mixture at a predetermined temperature and time to form an effective permeable liner/coating. The temperature of curing can generally be in the range of from about 120° C. to about 250° C. in one embodiment. The curing can be carried out at various temperature ranges including for example from about 120° C. to about 150° C. in one embodiment, from about 150° C. to about 200° C. in another embodiment, and from about 200° C. to about 250° C. in still another embodiment. If the curable epoxy composition is applied below the recommended curing temperature, the permeable liner may not be fully cured. If the curable epoxy composition is applied above the recommended curing temperature, the permeable liner may degrade. In both cases the contaminant-capturing particulate material might not be retained in the permeable liner.

The heating time to form the liner may be, for example, generally from about 3 minutes (min) to about 120 min in one embodiment, from about 3 min to about 60 min in another embodiment, and from about 3 min to about 30 min in still another embodiment. In general, the heating time for the liner will depend on the composition and reactivity of the resin composition. Too long of a curing time may degrade the polymer liner; and too short of a curing temperature may not allow the liner to cure properly.

Removing the gloss layer of the polymer liner is achieved by using Brush-off Blast Cleaning (a.k.a. Sweep blasting) as described by surface preparation specification SSPC-SP16 Brush-off Blast Cleaning of Non-Ferrous Metals from The Society for Protective Coatings. The sweep blasting of the liner may remove, for example, from about 10 to about 100 microns in one embodiment, from about 20 to 50 microns in another embodiment. In general, the sweep blasting of the coating will depend on the thickness of the gloss layer of the cure liner. Too much sweep blasting could damage the liner or remove too much of the permeable liner; and too little sweep blasting would not remove enough of the gloss layer, reducing the efficiency of the liner to capture for instance radionuclides and/or sulfides; the removal of the gloss layer could be optional if the gloss layer contains significant amount of pin-holes.

The composition for the liner is made using equipment for compounding powder coatings and specifically fusion bonded epoxy known by those skilled in the art, for example the interior surface of a pipe member. The process of the present invention for applying the composition onto a pipe member includes for example, spraying, curing and quenching the pipe member as is known and practice by those skilled in the art. The curable coating composition of the present invention may be applied to a substrate, for example pipes and tubes, in the field or in a factory facility. The coating compositions of the present invention are also suitable for coating pipes with no coatings thereon or pipes with an anti-corrosive coating thereon, and for maintenance coating applications. The process of forming the liner layer of the present invention and applying the liner to a substrate may be a batch process, an intermittent process, or a continuous process using equipment well known to those skilled in the art.

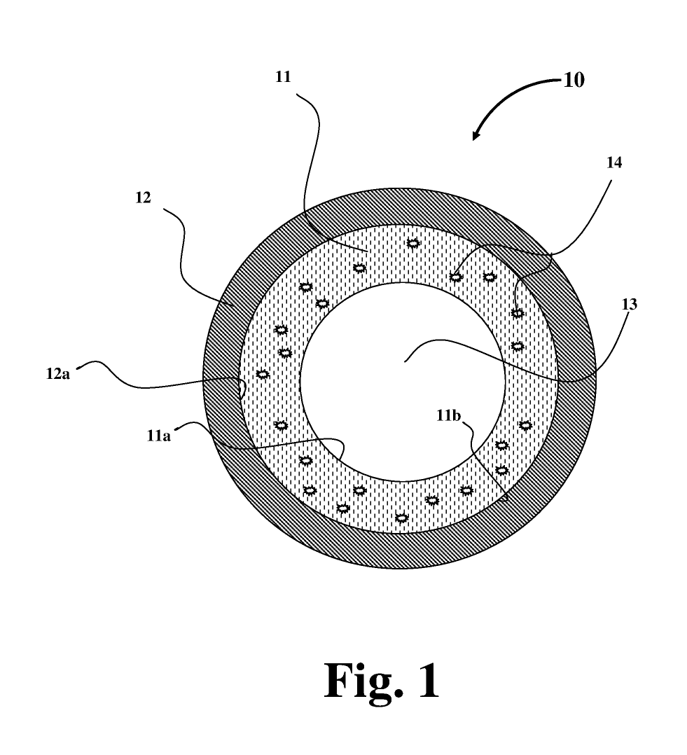

With reference to FIG. 1, there is shown a multi-layer article, in this case, a cylindrical structure, generally indicated by numeral 10. The cylindrical structure can be for example a pipe structure 10 which includes a liner/coating layer 11 (herein “liner layer 11”) integrally attached to the interior surface 12a of a substrate layer 12 such as a steel pipe. The interior surface 11a of the liner layer 11 forms the inner space of the pipe structure which is indicated by numeral 13. As shown in FIG. 1, a filler particle material 14 is embedded and integrally incorporated in the liner layer 11.

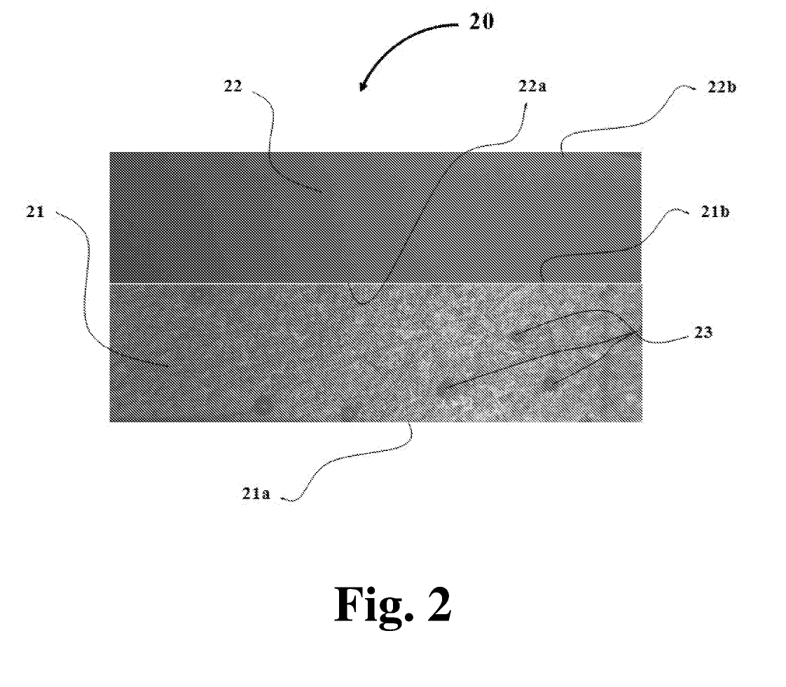

With reference to FIG. 2, there is shown a micrograph image of a multi-layer article, in this instance a section of a pipe structure, generally indicated by numeral 20. The cylindrical layered pipe structure 20 includes liner layer 21 having an inner surface 21a and an outer surface 21b; and a pipe substrate 22 with an inner surface 22a and an outer surface 22b. The liner layer 21 is integrally attached to the interior surface 22a of a pipe 22 such as a steel pipe 22. FIG. 2 also shows a plurality of particulate matter 23, such as barium sulfate or Zinc oxide particles 23, embedded and integrally incorporated in the liner 21.

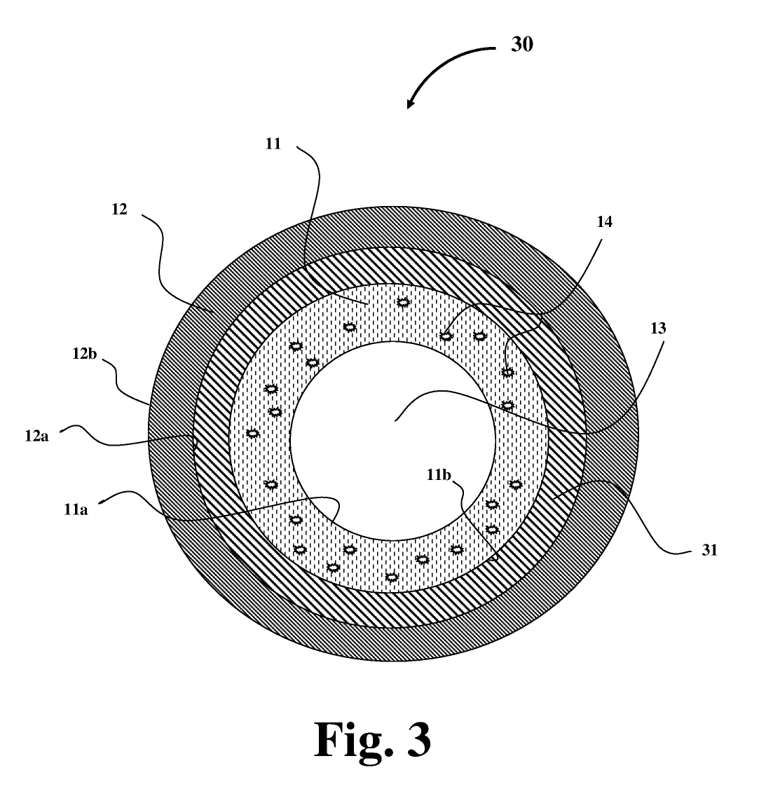

The powder coating composition of the present invention can be applied direct to a metal substrate as shown in FIG. 1. However, in highly corrosive environments it is desirable to add a primer layer between interior surface 12a and exterior surface 11b, i.e., in between the substrate layer 12 and the liner layer 11 as shown in FIG. 3 as primer layer 31. With reference to FIG. 3, there is shown a primer layer 31 disposed between the liner layer 11 and the substrate layer 12, i.e., such as a pipe member 12. The primer can be any of the commercially available products for downhole applications like the Nap-Gard® No. 7-1808, Scotchkote 500N water base primer, Scotchkote 345 liquid phenolic primer, KARUMEL PP100, and mixtures thereof.

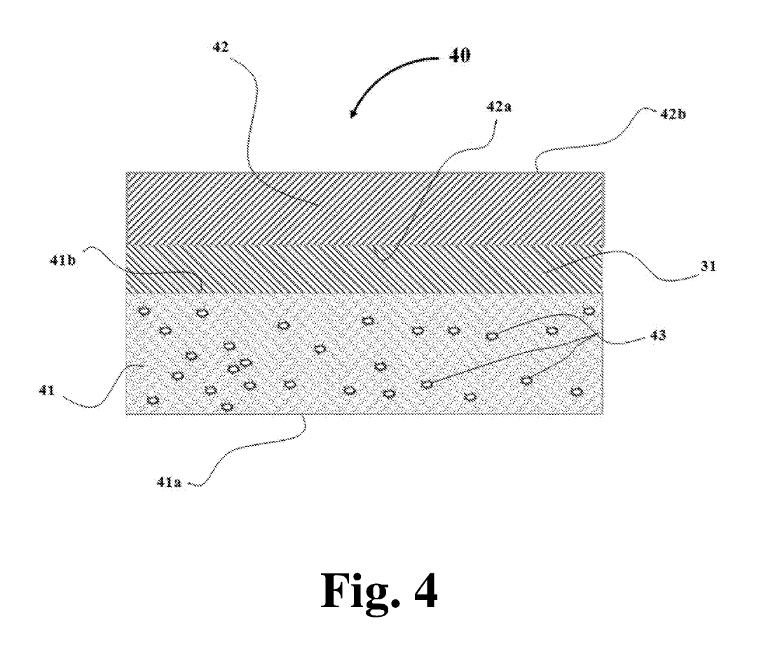

With reference to FIG. 4, there is shown a multi-layer article, in this instance a section of a pipe structure, generally indicated by numeral 40. The cylindrical pipe layered structure 40 such as a steel pipe 40 includes liner layer 41 having an inner surface 41a and an outer surface 41b; and a pipe substrate 42 with an inner surface 42a and an outer surface 42b. The primer layer 31 is integrally attached in between the liner layer 41 and the pipe member 42. The primer layer 31 may be integrally attached to the interior surface 42a of the pipe 42 and integrally attached to the outer surface 41b of the liner 41. FIG. 4 also shows a plurality of particulate matter 43, such as barium sulfate or ZnO particles 43, embedded and integrally incorporated in the liner 41.

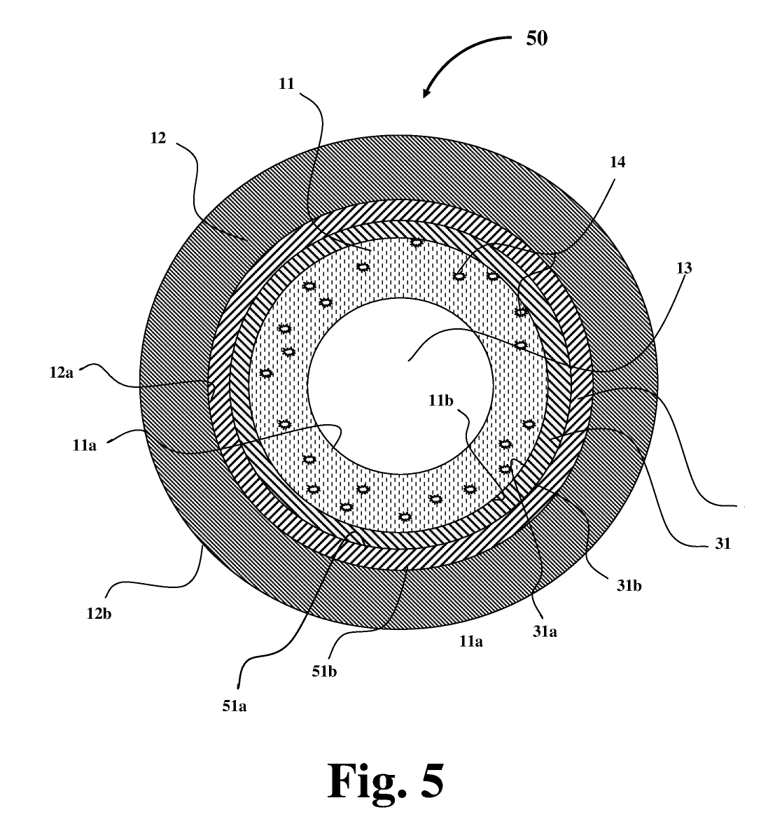

In another embodiment as shown in FIG. 5, a mid-layer 51 can be added to the liner member 50. With reference to FIG. 5, the mid-layer 51, if used, may be disposed in between the primer layer 31 and the liner layer 11. The cylindrical pipe structure 50 such as a steel pipe 50 includes liner layer 11 having an inner surface 11a and an outer surface 11b; and a pipe substrate 12 with an inner surface 12a and an outer surface 12b. The mid-layer 51 is integrally attached in between the primer layer 31 and the liner layer 11. The mid-layer layer 51 may be integrally attached to the outer surface 31a of the primer layer 31 and integrally attached to the inner surface 51a of the mid-layer 51. FIG. 5 also shows a plurality of particulate matter 14, such as barium sulfate or ZnO particles 14, embedded and integrally incorporated in the liner 11.

The mid-layer of the powder coating of the present composition, can be any commercial liquid of powder liner like Scotchkote™ Fusion-Bonded Epoxy Coating XC-6171, KARUMEL FBE IC4888, Nap-Gard® 7-0008, 7-18014, 7-18017, PIPECLAD PFG70002, TK coatings, and mixtures thereof. Scotchkote is a trademark of 3M, Nap-Gard is a trademark of Axalta, KARUMEL is a trademark of KCC, PIPECLAD is a trademark of Valspar. TK is a trademark of NOV tuboscope. The composition of the present invention can be applied using the same process used to apply the primer and mid-layer mentioned above.

With reference again to FIG. 1, the liner 11 (herein referred to as the “liner layer”) of article 10 (herein referred to as the “pipe”) may be made of any conventional curable polymer resin including for example a thermosetting resin, a thermoplastic resin, or a combination thereof. In a preferred embodiment, the liner layer resin composition includes any of the epoxy resins described above such as for example bisphenol-A-based resins, bisphenol-F-based resins, and other known epoxides and curable (thermosetting) resins; and mixtures thereof. For example, in a preferred embodiment, the liner layer 11 may be made of a thermosetting resin such as one or more epoxy resins.

One of the key properties of the liner layer 11 is its capability of removing contaminants such as radium-226 or sulfides. For this capability, the liner layer 11 contains a plurality of particles 14 integrally incorporated in the body of the liner layer 11. The particles 14 can be for example barium sulfate (BaSO₄ or ZnO), or any of the contaminant-capturing materials described above.

In one embodiment, the liner layer 11 of the pipe 10 of the present invention is adhered to a pipe substrate layer 12. The pipe substrate layer 12 can be made of a metal such as steel, a composite material, or a combination thereof. In one preferred embodiment, the pipe substrate layer 12 is made of steel. As shown in FIG. 1, the liner layer 11 is integrally bonded to the interior surface 12a of the steel pipe substrate layer 12. The steel pipe used in the present invention may include for example pipes that meet API Specification 5CT grades also called Oil Country Tubular Goods (OCTG) produced by TENARIS, SANDVIK, TECHNIP, VALLUREC, ArcelorMittal among others. Moreover, a composition such as a powder composition, can be applied by companies like Bredero-Shaw and Tuboscope among others.

After the preferable removal of the gloss layer, the thickness of the liner layer 11 of the pipe 10 can generally be from about 1,500 microns to about 7,500 microns in one embodiment, from about 500 microns to about 2,500 microns in another embodiment, and from about 250 microns to about 1,300 microns in still another embodiment, and from about 130 microns to about 700 microns in yet another embodiment.

Any number of optional layers can be added to the layered construction of the article 10. For example, an optional primer layer may be made of commercially available products for downhole applications such as Nap-Gard® No. 7-1808, and any of the other commercial products described above. In one preferred embodiment, the optional layer if used may be made of specifically any commercial liquid of powder liners such as Scotchkote™ Fusion-Bonded Epoxy Coating XC-6171 and any of the other commercial products described above The primer and mid-layer mentioned above can be applied to the substrate and/or other layers using the same process used to apply the curable composition (liner) as described above. One of the beneficial properties of the primer layer and/or mid-layer is to provide corrosion protection to the steel pipe and good adhesion to the composition of the present invention.

In one embodiment, the optional layer of the article structure such as pipe 10 of the present invention may be adhered in between the inner surface 12a of the substrate layer 12 and the outer surface 11b of the liner layer 11.

The thickness of the optional primer layer of the pipe 10 can generally be from about 500 microns to about 1,000 microns in one embodiment, from about 250 microns to about 500 microns in another embodiment, and from about 100 microns to about 200 microns in still another embodiment.

The thickness of the optional mid-layer of the pipe 10 can generally be from about 1,000 microns to about 2,000 microns in one embodiment, from about 500 microns to about 1,000 microns in another embodiment, and from about 250 microns to about 500 microns in still another embodiment.

In its broadest scope, the present invention includes an article containing a liner layer for removal of contaminants such as radionuclides or sulfides; and the liner includes bonding at least one liner layer 11 to the inside surface 12a of a substrate layer 12 to form a single article such as a pipe 10. The pipe structure of pipe 10 is shown in FIG. 1 with two layers (11 and 12) to form a multi-layer construction. However, the number of layers for pipe 10 is not limited to the layers as shown in FIG. 1. Any number of layers can make up the overall multi-layer pipe structure 10. For example, the number of layers can generally be from about 1 to about 5 in one embodiment, from about 1 to about 4 in another embodiment, and from about 1 to about 3 in still another embodiment.

The present invention incorporates into the liner layer 11 used to manufacture a pipe 10, a mechanism for removing radionuclide and sulfides (e.g., BaSO₄ or ZnO crystals or particles) and other contaminants resulting in a light-weight pipe for contaminant capture. Furthermore, since the contaminant-removing liner layer 11 is manufactured to fit the pipe diameter, the diameter of the pipe is not limited, i.e., the pipe can be made to be very narrow, which is advantageous because with a narrow pipe, the user of the pipe does not require a thick metal even for high pressure situations (for example hydraulic fracturing). By having radium or sulfide capture occur on the composite pipe itself, downwell rather than above ground, this can advantageously eliminate or lessen the need for an above-the-ground treatment of the water and other fluids coming out of the well.

With the liner layer 11, preferable without the gloss layer, forming a part of the pipe 10, the pipe 10 can be useful for enduses that require removing contaminants from a fluid flowing through the center/interior 13 of the pipe 10. The amount of contaminant may depend on the application of the pipe 10, the type of contaminants in the liquid or gas, and the type of liquid or gas being passed through the center of the pipe. For example, the liner layer 11 of the present invention can generally remove contaminants up to about 50,000 picoCuries of Ra-226 per linear feet of pipe in one embodiment, from about 2,000 picoCuries of Ra-226 to about 20,000 picoCuries of Ra-226 per linear feet of pipe in another embodiment, from about 1,000 picoCuries of Ra-226 to about 10,000 picoCuries of Ra-226 per linear feet of pipe in still another embodiment, and from about 500 picoCuries of Ra-226 to about 5,000 picoCuries of Ra-226 per linear feet of pipe in yet another embodiment.

In another example, the liner layer 11 of the present invention can generally remove contaminants up to about 50,000 ppm of H₂S per linear feet of pipe in one embodiment, from about 2,000 ppm of H₂S to about ppm of H₂S per linear feet of pipe in another embodiment, from about 1,000 ppm of H₂S to about

10,000 ppm of H₂S per linear feet of pipe in still another embodiment, and from about 500 ppm of H₂S to about 5,000 ppm of H₂S per linear feet of pipe in yet another embodiment.

In addition, the liner layer 11, of the present invention exhibits unexpected and unique properties such as better removal of radionuclide and sulfites after the removal of the gloss layer.

Generally, the process for integrally bonding the liner layer described above to the interior surface of a pipe structure to form a pipe coated with the liner layer is carried out by coating process known in the art (e.g., the method for coating the inner surface of metal pipes as described in U.S. Pat. No. 3,814,616A, incorporated herein by reference).

For example, in general, fabricating a pipe with the liner can be done by the steps of (1) heating the pipe, (2) applying the powder coating to the interior surface of a pipe such that the powder coating particles stick to the surface of the pipe; and (3) allowing the powder coating to cure long enough to form a solid permeable liner member integrally attached to the pipe member, (4) quenching the pipe to avoid thermal degradation of the permeable FBE liner and (5) light sweep blast of the FBE permeable liner to remove the gloss surface (approx. 25 microns).

Optionally a primer and a mid-coat can be applied to the pipe member prior to the application of the permeable liner. Optionally the inner surface of the metal pipe can be cleaned by sandblasting, washing, phosphating the inner surface of the metal pipe to provide better adhesion of the permeable liner to the pipe.

The applying step (1) can be carried out by spraying the FBE powder coating onto the inside surface of the pipe member. The heating step (2) can be carried out by preheating the pipe or heating the pipe as the powder coating is applied to the inside surface of the pipe or by heating the pipe after the curable powder coating is applied.

Some non-limiting examples of enduse applications for the permeable liner and pipe structure product of the present invention may include, for example, removal of radionuclides like Radium, removal of H₂S, removal of CO₂, reduction of asphaltenes deposition, and protection against corrosion since capturing agent may enable self-passivation of the coating. For example, as discussed in in U.S. Patent Publication No. 2012/0164324, a metal oxide layer that is reactive with hydrogen sulfide is disclosed, upon which reaction with hydrogen sulfide the metal oxide layer forms a barrier layer that resists the transmission of hydrogen sulfide across it. This modified metal oxide layer is conceived of as a self-passivating layer in that reactivity toward hydrogen sulfide is diminished over time in the presence of hydrogen sulfide. Yet, its barrier properties, with respect to the transmission of hydrogen sulfide, are enhanced as a function of the extent to which the modified metal oxide layer has been converted to a sulfide or oxysulfide barrier layer. However, to achieve such self-passivation, U.S. Patent Publication No. 2012/0164324 requires a coating composition that includes a metal oxide precursor material that is susceptible to conversion to the corresponding metal oxide, which precursor material may be may be a metal derivative that which upon reaction with water forms the corresponding metal oxide (as is the case of zinc acetate and tetraethyl orthosilicate) or a metal derivative that which may be transformed into a metal oxide without the intervention of water (such as a metal oxalate). In contrast, the exemplary embodiments relate to enabling self-passivation, in addition to the benefits associated with the polymer resin matrix, without requiring special additives.

In an exemplary embodiment, the pipe coated with the liner of the present invention may be used to remove or reduce the contaminants in a liquid or gas passing through the center space of the pipe and coming into contact with the liner containing contaminant-capturing material such that the liner sequesters the contaminants in the body of the liner layer.

The contaminated liquid may include, for example, water, brine, a blend of crude oil and water, or a mixture of crude oil and brine.

The contaminant-capturing particulate used in the present invention may include, for example, metal sulfates, metal oxides, and/or any combination thereof. The contaminant-capturing particulate, e.g., barium sulfate particles, are solids at room temperature. The contaminant-capturing particulate may have a melting point greater than 500° C., greater than 800° C., and/or greater than 1,000° C. The melting point of the contaminant-capturing particulate may be less than 2,500° C. Exemplary metal sulfates include alkali metal sulfates and alkaline earth metal-sulfates. Exemplary metal sulfates include barium sulfate, strontium sulfate, and mixtures thereof. In one preferred embodiment, the contaminant-capturing particulate is barium sulfate. For removing hydrogen sulfide from and aqueous media, exemplary metal oxides include manganese oxides such as manganese (II) oxide (MnO), manganese (II,III) oxide (Mn₃O₄), manganese(III) oxide (Mn₂O₃), manganese dioxide (MnO₂), and manganese(VII) oxide (Mn₂O₇). Exemplary manganese oxide based minerals include birnessite, hausmannite, manganite, manganosite, psilomelane, and pyrolusite, and mixtures thereof. As described in U.S. Pat. No. 6,740,141 B2, incorporated herein by reference, the metal for removing H₂S and CO₂ is preferably a metal selected from the group consisting of calcium, magnesium, zinc, iron and other metals from groups 8, 9 or 10 or the periodic table of elements (CAS Group VIII). For adsorption of H₂S in and organic-rich media like oil, the most preferred material is calcium oxide (CaO), and for adsorption of CO₂, the most preferred material is calcium oxide coated with iron oxide ([Fe₂O₃]CaO).

In general, the percentage amount of contaminant removed from the liquid may be from about 20% to about 80% in one embodiment, from about 40% to about 70% in another embodiment, and from about 50% to about 60% in still another embodiment

In one illustrative embodiment, and not limited thereto, a contaminated liquid from an oil well can be used in the present invention and the contaminant to be reduced or eliminated from the liquid is a radionuclide. When the liquid at 90° C. with a 20% water cut is flowing at a rate of 10 thousand barrels a day (mbd) inside the pipe having a diameter of about 8.8 cm, the amount of radionuclide removed from the liquid may be from about 20% to about 80% in one embodiment, from about 40% to about 70% in another embodiment, and from about 50% to about 60% in still another embodiment.

### EXAMPLES

The following examples and comparative examples further illustrate the present invention in more detail but are not to be construed to limit the scope thereof.

In the following Examples, various materials, terms and designations are used and are described in the following Tables I:

TABLE I
Raw Materials

| Raw Material | Description | Owner |
|---|---|---|
| Alkanolamine modified solid epoxy | THAM modified 4-type epoxy resin Epoxy | Not applicable |
| resin | Equivalent Weight 800 as measured. (900 | |
| | for formulation purposes) | |
| D.E.R. 664 UE | 4-type Solid Epoxy Resin. Epoxy Equivalent | Olin Epoxy, a division |
| | Weight From 860 to 930 | Olin Corp |
| D.E.R. 672U-20 | Novolac modified high molecular weight, | Olin Epoxy, a division |
| | solid epoxy resin. Epoxy Equivalent Weight | Olin Corp |
| | From 740 to 830 | |
| D.E.H. 82 | Phenolic hardener containing | Olin Epoxy, a division |
| | 3.5% curing accelerator and | Olin Corp |
| | 2.5% flow modifier. Phenolic OH | |
| | Equivalent Weight from 235 to 265 | |
| Alakanolamine and liquid epoxy | THAM-LER adduct Amino hydrogen | Not applicable |
| adduct | Hardener 404 (Average Amino Hydrogen | |
| | Equivalent Weight) | |
| Epikure ™ P101 | 2-methyl imidazole adduct with liquid epoxy | Momentive |
| | resin | |
| Modaflow Powder III | 60%-70% ethyl acrylate-2-ethylhexyl | Cytec |
| | acrylate copolymer and | |
| | 30%-40% silicon dioxide | |
| ExBar ™ W1 | 98.9% purity of barium sulfate, described as | Excalibar |
| | having approximately 1 μm sized average | |
| | particles | |
| SLZ1009 | A powder that is described as including 99 | UNICAT Catalyst |
| | wt % of zincOxide. | Technologies |
| VANSIL ® W-20 | Wollastonite (calcium metasilicate) | Vanderbilt Minerals, |
| | | LLC |

### Preparation of the THAM Modified Solid Epoxy Resin

The synthesis of the Alkanolamine modified solid epoxy resin is conducted in one liter glass kettle. 697.81 grams of D.E.R 383 liquid epoxy resin (LER) and 289.6 grams of Bisphenol A (BPA), from Olin Corporation, are weighted directly into the kettle. The kettle is then covered with a three 20/40 joints reaction flask head and place on the heating mantle. A half-moon metal stirrer is placed in the flask head center joint. Another joint is fitted with nitrogen pad and a thermocouple. The last joint is capped with a rubber septum and used to add catalysis, alkanolamine and take samples. The stirrer and heating mantel power is switch on and the temperature of the LER/BPA slurry is allowed reach about 90° C. After the BPA is dissolved in the LER, 1.26 grams of ethyltriphenylphosphonium acid acetate is added to the LER/BPA blend. The reaction temperature is increased to about 140° C. with the heating mantel. The heating mantle is switch off and the exotherm is allowed to reach 180-190° C. A sample is taken half an hour after the peak exotherm to confirm the targeted epoxy equivalent weight (EEW) has been reached. The material is allowed to cold down to about 175° C. At this point 12.62 grams of Tris(hydroxymethyl)aminomethane (THAM) ACS reagent, ≥99.8% from Sigma Aldrich is added to the reactor and the heating mantel is switch on to maintain the temperature inside the reactor in the 165 to 175° C. range. A sample is taken half an hour after the addition of the THAM to confirm the targeted EEW has been reached. The stirrer and heating mantel are switch off and the resulting alkanolamine modified solid epoxy resins is the poured out. The EEW of the epoxy resin after the peak exotherm is about 763 and about 900 after the THAM addition. The melt viscosity of the alkanolamine modified solid epoxy resin is about 9.5 Pa·sec.

### Preparation of the THAM-LER Adduct Hardener

The synthesis of the Alakanolamine and liquid epoxy adduct is conducted in 250 ml glass kettle covered with a three 20/40 joints reaction flask head. The central joint is used to place the half-moon metal stirrer. Another joint is fitted with a nitrogen pad and thermocouple. The last joint is fitted with a 150 ml addition flask. 72.9 grams of THAM is weighted directly into the reaction kettle and 127.1 grams of D.E.R 383 in the addition flask. About 27 grams of D.E.R 383 is mixed with the THAM to make slurry, which is stirred and then heated up using dual heating lamps to 80° C. The temperature of the slurry is increased just above the melting point of the THAM (about 172° C.) and the dropwise LER addition is initiated while the temperature is monitored and maintained about 175° C. Half an hour after the LER addition is completed a sample is taken to confirm the amino hydrogen equivalent weight (AHEW) has been reached. The resulting molten THAM-LER adduct hardener is poured out. The resulting amine number is about 170 mg of KOH equivalents or in average 404 AHEW.

### Working Examples 1-3 and Comparative Examples A and B

A batch size of 1 kg was prepared for each formulation described in Table II. The pre-mixing of the formulation components was performed in a Prism Pilot 3 mixer (2300 RPM for 15 seconds). Each premixed formulation was compounded at 200 RPM using a Prism TSE 24PC twin screw extruder with three barrel heat zones. The barrel heat zones were 25° C., 75° C. and 85° C. 0.5% Cabosil M5 was added to each formulation after compounding. A Hosokawa Micro-ACM Model 2 grinder was used to reduce the compounded flakes to a fine fusion bonded epoxy (FBE) powder of 50 microns average particle size.

The FBE powder coating formulations described in Tables II were applied to Polytetrafluoroethylene (PTFE) panels (20×7×1.0 cm) using a fluidizing bed. The PTFE panels were preheated in an oven at 242° C. for a minimum of half an hour (30 minutes [min]) before dipping them into the fluidizing bed. After the panels were dipped into the fluidizing bed long enough to achieve the targeted coatings thickness of about 400 microns, the coated panels were post cured in an oven at 242° C. for 3 min. Then, coated PTFE panels were quenched in tap water for about 2-3 min. Coating films were then removed from the PTFE panels for the removal of contaminant test. Samples of the cured coating film were tested using Canadian Standard Z245.20 series 10 section 12.7 Thermal characteristics of the epoxy powder and coating to measure the glass transition temperature of the film. The dry glass transition temperature of the film was measured after drying the film in a desiccator for 24 hrs. The wet glass transition temperature was measured after the cured coating films were submerged in deionized water for 24 hrs. at 90° C.

TABLE II
Curable Epoxy Thermoset Compositions
for Powder Coatings for Capturing

| | | | | |
|---|---|---|---|---|
| Working | Comp. | Working | Working | Comp. |
| Ex. 1 | Ex. A | Ex. 2 | Ex. 3 | Ex. B |

Formulation Components (wt %)

| | | | | | |
|---|---|---|---|---|---|
| Alkanolamine | 26.9 | 26.9 | 31.8 | | 31.8 |
| modified solid | | | | | |
| epoxy resin | | | | | |
| D.E.R 664UE | | | | 32.0 | |
| D.E.R 672U-20 | | | 8.0 | 8.0 | 8.0 |
| D.E.H 82 | | | 10.2 | 10 | 10.2 |
| Alakanolamine | 11.5 | 11.5 | | | |
| and liquid | | | | | |
| epoxy adduct | | | | | |
| Epikure P101 | 0.78 | 0.78 | | | |
| Modaflow | 0.86 | 0.86 | | | |
| powder III | | | | | |
| ExBar ™ W1 | 60.0 | | 50 | 50 | |
| VANSIL W-20 | | 60.0 | | | 50 |
| Total | 100 | 100 | 100 | 100 | 100 |

Properties

| | | | | | |
|---|---|---|---|---|---|
| Dry glass transi- | 102 | 103 | 104 | 105 | 105 |
| tion temperature | | | | | |
| (° C.) | | | | | |
| Wet glass transi- | 85 | 86 | 89 | 91 | 90 |
| tion temperature | | | | | |
| (° C.) | | | | | |
| Dry-Wet Tg | 17 | 17 | 16 | 14 | 16 |
| Range (° C.) | | | | | |

Referring to Table II, it is seen that each of Working Examples 1-3 and Comparative Examples A and B can be regarded as permeable. Further, it is seen that the highest Dry-Wet Tg Range (greater than 16° C.) is realized for the examples containing the alkanolamine modified solid epoxy resin. It is believed the epoxy materials in each of Working Examples 1 to 3 may be used in varying combinations to optimized desired properties.

The dry Tg and the wet Tg (also referred to as moisture conditioned Tg) are determined according to Canadian Standard Z245.20 series 10 section 12.7 Thermal characteristics of the epoxy powder and coating to measure the glass transition temperature of the film. The Tg can also be determined using dynamic mechanical-thermal analysis (DMTA) and Tg data is obtained on a TA Instrument ARES Rheometer. The Tg can also be measured by the method described in ASTM such as the differential scanning calorimetry (DSC) ASTM E 1356 standard test method for assignment of the glass transitions temperatures by differential scanning calorimetry and ASTM D-7028.

### General Procedure for Testing Contaminant Removal

Coating Strips, 4×1 cm in size, were cut from the above films; half of the strips were sanded to remove the gloss layer. The strips were used for a radionuclide removing test using the following procedure:

A standard solution of Ra-226 was purchased from Isotope Products Laboratories. This solution was diluted to obtain a working solution. Portions of the working solution were then dispensed by pipetting for performing this test.

A liter of a brine solution containing 5.0 and 2.6 percent by weight of NaCl and CaCl₂ respectively was prepared. The pH of the solution was adjusted to be between 7.5 and 8.0 using solutions of sodium hydroxide and hydrochloric acid.

A portion of brine was weighed out for each test and 2.457 mL of a solution containing approximately 5,000 picoCuries of Ra-226 was added to the composition. Then the pH of the composition was readjusted. One of these portions was added to a pre-weighed sample of material to start each test.

The measurement of Ra-226 content in the brine samples was done by Liquid Scintillation Counting (LSC) before and after exposure was completed. The measurement of Ra-226 content in the coating material was done by Gamma-ray Spectrometry.

Before the Liquid Scintillation Counting above, each aliquot was gently evaporated in order to expel Rn-222, which interfered with the Ra-226 measurement. Rn-222 did gradually grow in prior to measurements. Two counting windows were used: one registered the counts due to both Ra-226 and Rn-222, and another registered the counts only due to Rn-222. A correction factor was established using water from a Radon generator and was used to correct for Rn-222 interference on Ra-226.

The sanded and un-sanded coating film strips and brine were placed in 500 mL glass bottles. Then the glass bottles containing the strips and the brine were placed in an electric oven at 90° C. The mixture was mixed by swirling several times during each experiment.

The brine was sampled for Liquid Scintillation Counting before mixing with material, immediately after mixing, at 3 days and at 7 days. Duplicate aliquots were taken at 3 and 7 days.

After the final sampling, the brine was thoroughly drained from the material and the material was then packaged for gamma-ray spectrometry.

Table III shows the results of the Rn-222 fraction remaining in the brine after 7 days in contact with coated panels at 90° C. and the Ra-226 Activity (Bq) in the coated panel containing the contaminant-capturing material.

TABLE III
Radionuclide Fraction Removed from Brine after 7 Days at
90° C. in Contact With sanded and un-sanded Coating Films

| | Working | Comp. | Working | Working | Comp. |
|---|---|---|---|---|---|
| | Ex. 1 | Ex. A | Ex. 2 | Ex. 3 | Ex. B |
| Un-sanded Film | 23% | 3% | 2% | 2% | 1% |
| Sanded Film | 71% | 5% | 29% | 14% | 4% |

Referring to Table III, it is seen that higher percentage of capture of Ra-226, is realized for each of Working Examples 1 to 3. In contrast, Comparative Examples A to B, which do not include barium sulfate in the coating, each shows significantly, lower percentage of capture of Ra-226.

The Powder from Working Example 1 and Comparative Example A were then applied to 2×6′ black steel pipe nipples (PN), which were cleaned first according to SSPC (The Society for Protective Coatings Surface) Preparation Standard No. 1 and 11. The cleaned pipe nipples were treated with a 5% aqueous solution of phosphoric acid and then washed with deionized water till neutral pH. Corvel® EP 10 (a phenolic based primer) was applied and cured as recommended by the supplier. The PNs primed with Corvel® EP 10 were preheated in an oven at 232° C. for a minimum of half an hour (30 minutes [min]) before dipping them into the fluidizing bed containing the powder coating of working example 1. After the PNs were dipped into the fluidizing bed long enough to achieve the targeted coatings thickness of about 500 microns, the coated pipe panels were post cured in an oven at 232° C. for 3 min. Then, coated PNs were quenched in tap water for about 2-3 min. The coating inside the PNs was sanded to remove the gloss layer, about 25 microns, before the contaminant removal test similar to the one use for the coating films. PN1 was coated with Working Example 1, PNA was coated with Comparative Example A.

TABLE IV
Radionuclide Fraction Removed from Brine after
7 Days at 90° C. in Contact With sanded liners

| | | ²²⁶Ra removed |
|---|---|---|
| | Sample ID | from Brine (%) |
| Day 0 | Baseline | 0% |
| Day 1 | PN1 | 50% |
| | PNA | 4% |
| Day 3 | PN1 | 58% |
| | PNA | 5% |
| Day 7 | PN1 | 65% |
| | PNA | 6% |

Referring to Table IV, it is seen that higher percentage of capture of Ra-226, is realized for the samples coated with Working Example 1. In contrast, the samples coated with Comparative Example A, which do not include barium sulfate in the coating, show significantly, lower percentage of capture of Ra-226.

TABLE V
Curable Epoxy Thermoset Compositions
for Powder Coatings for Capturing H₂S

| | | | | |
|---|---|---|---|---|
| Working | Comp. | Working | Working | Comp. |
| Ex. 4 | Ex. C | Ex. 5 | Ex. 6 | Ex. D |

Formulation Components (wt %)

| | | | | | |
|---|---|---|---|---|---|
| Alkanolamine | 26.9 | 26.9 | 31.8 | | 31.8 |
| modified solid | | | | | |
| epoxy resin | | | | | |
| D.E.R 664UE | | | | 32.0 | |
| D.E.R 672U-20 | | | 8.0 | 8.0 | 8.0 |
| D.E.H 82 | | | 10.2 | 10 | 10.2 |
| Alakanolamine | 11.5 | 11.5 | | | |
| and liquid | | | | | |
| epoxy adduct | | | | | |
| Epikure P101 | 0.78 | 0.78 | | | |
| Modaflow | 0.86 | 0.86 | | | |
| powder III | | | | | |
| Unicat Zinc | 60.0 | | 50 | 50 | |
| Oxide | | | | | |
| VANSIL W-20 | | 60.0 | | | 50 |
| Total | 100 | 100 | 100 | 100 | 100 |

Properties

| | | | | | |
|---|---|---|---|---|---|
| Dry glass transi- | 103 | 104 | 105 | 105 | 105 |
| tion temperature | | | | | |
| (° C.) | | | | | |
| Wet glass transi- | 84 | 86 | 90 | 91 | 89 |
| tion temperature | | | | | |
| (° C.) | | | | | |
| Dry-Wet Tg | 19 | 18 | 15 | 14 | 16 |
| Range (° C.) | | | | | |

Working Examples 4-6 and Comparative Examples C and D are similar to Working Examples 1-3 and Comparative A and B, respectively, except include zinc oxide. The approximate conditions (e.g., with respect to time and amounts) and properties for forming Working Examples 4-6 and Comparative Examples C and D, are discussed below.

For Working Examples 4, 5, and 6 and Comparative Example C and D, a batch size of 1 kg was prepared for each formulation described in Table V. The pre-mixing of the formulation components was performed in a Prism Pilot 3 mixer (2300 RPM for 15 seconds). Each premixed formulation was compounded at 200 RPM using a Prism TSE 24PC twin screw extruder with three barrel heat zones. The barrel heat zones were 25° C., 75° C. and 85° C. 0.5% Cabosil M5 was added to each formulation after compounding. A Hosokawa Micro-ACM Model 2 grinder was used to reduce the compounded flakes to a fine fusion bonded epoxy (FBE) powder of 50 microns average particle size. The FBE powder coating formulations described in Tables II were applied to Polytetrafluoroethylene (PTFE) panels (20×7×1.0 cm) using a fluidizing bed. The PTFE panels were preheated in an oven at 242° C. for a minimum of half an hour (30 minutes [min]) before dipping them into the fluidizing bed. After the panels were dipped into the fluidizing bed long enough to achieve the targeted coatings thickness of about 400 microns, the coated panels were post cured in an oven at 242° C. for 3 min. Then, coated PTFE panels were quenched in tap water for about 2-3 min. Coating films were then removed from the PTFE panels for the removal of contaminant test. Samples of the cured coating film were tested using Canadian Standard Z245.20 series 10 section 12.7 Thermal characteristics of the epoxy powder and coating to measure the glass transition temperature of the film. The dry glass transition temperature of the film was measured after drying the film in a desiccator for 24 hrs. The wet glass transition temperature was measured after the cured coating films were submerged in deionized water for 24 hrs. at 90° C.

Working Examples 4, 5, and 6 and Comparative Example C and D are evaluated for hydrogen sulfide capture. The evaluation for hydrogen sulfide captures includes: (i) hydrogen sulfide content in vapor phase after 1 hour of exposure, in parts per million by volume (ppmv), and (ii) hydrogen sulfide capture, in percent. The evaluation is carried out using the Working Examples that contains 0.2 grams of the Zinc Oxide and the ones of the Comparative Examples without Zinc Oxide, but similar amount of the polymer used in the Working Examples. Samples were placed in 10 mL of deionized water in a GC vial, at a temperature of 70° C. As would be understood by a person of ordinary skill in the art, hydrogen sulfide content in vapor phase is measured by an Agilent gas chromatography equipped with a Restek Rt-Q-Bond column, a thermal conductivity detector, and pulsed discharge ionization detector.

Hydrogen sulfide capture efficiency is calculated by comparing with a blank sample in the absence of coating, as would be understood by a person of ordinary skill in the art.

In particular, for the hydrogen sulfide capture studies of the corresponding coating samples are weighted into a 22-mL headspace GC vial with a stir bar. Then, deionized water (10 mL) is added into each vial and sealed with a PTFE lined silicon crimp cap. Next, hydrogen sulfide gas (1.5 mL, STP equivalent to 2.28 mg) is injected into the headspace of each vial. The vials are then heated at 70° C. on top of a stirring hot plate for 1 hour. Thereafter, the vials are cooled and the hydrogen sulfide concentrations in the headspace of the vials are analyzed by headspace gas chromatography.

The results for coatings samples suspending in water are shown in Table IV, below:

TABLE IV

| | Working | Comp. | Working | Working | Comp. |
|---|---|---|---|---|---|
| | Ex. 4 | Ex. C | Ex. 5 | Ex. 6 | Ex. D |
| Amount of | 0.33 | 0.33 | 0.4 | 0.4 | 0.4 |
| Coating (grams) | | | | | |
| Amount of Poly- | 40 | 40 | 50 | 50 | 50 |
| mer Matrix in | | | | | |
| Coating (wt %) | | | | | |
| Amount of Zinc | 60 | — | 50 | 50 | — |
| Oxide in Coating | | | | | |
| (wt %) | | | | | |
| Zinc Oxide in | 60 | — | 50 | 50 | — |
| Coating (wt %) | | | | | |
| Amount Zinc | 0.2 | — | 0.2 | 0.2 | — |
| Oxide Powder (g) | | | | | |
| Hydrogen Sulfide | 598 | 1817 | 1667 | 1661 | 2230 |
| Content in Vapor | | | | | |
| Phase (ppmv) | | | | | |
| Hydrogen Sulfide | 80 | 39.4 | 44.4 | 44.6 | 25.7 |
| Capture (%) | | | | | |

Referring to Table IV, it is seen that low hydrogen sulfide content in vapor phase and higher percentage of capture of hydrogen sulfide, is realized for each of Working Examples 4 to 6. In contrast, Comparative Examples C and D, which do not include Zinc Oxide in the coating, each show significantly higher amount of hydrogen sulfide content in vapor phase and significantly lower percentage of capture of hydrogen sulfide.

1. A contaminant capturing liner, comprising:
a cured product of a composition including an epoxy resin component including at least one alkanolamine modified epoxy resin and at least one hardener, the contaminant capturing liner including at least one contaminant-capturing material embedded therewithin, and the contaminant capturing liner being a permeable layer having a difference between dry glass transition temperature and wet glass transition temperature of at least 14° C.

2. The contaminant capturing liner as claimed in claim 1, wherein the contaminant capturing liner is a powder coating.

3. The contaminant capturing liner as claimed in claim 1, wherein the contaminant capturing liner is a pre-formed liner applicable to a base substrate to form a coated article.

4. The contaminant capturing liner as claimed in claim 1, wherein the contaminant capturing liner is formable directly on a base substrate to form a coated article.

5. The contaminant capturing liner as claimed in claim 3, wherein the base substrate is a pipe having the contaminant capturing liner on an inner surface thereof.

6. The contaminant capturing liner as claimed in claim 1, wherein the base substrate is a pipe that is capable of having a liquid fluid through an inner surface thereof in contact with the contaminant capturing liner.

7. The contaminant capturing liner as claimed in claim 3, wherein the contaminant capturing liner is applied to the base substrate by a powder coating spray process.

8. The contaminant capturing liner as claimed in claim 1, wherein the contaminant capturing liner is sanded or abraded using sweep blasting to remove a gloss layer thereon.

9. The contaminant capturing liner as claimed in claim 1, wherein the epoxy component is present in an amount from 10 wt % to 60 wt %, and the at least one contaminant-capturing material is present in an amount from 15 wt % to 85 wt %, based on a total weight of the composition.

10. The contaminant capturing liner as claimed in claim 1, wherein the at least one contaminant-capturing material includes BaSO4, ZnO, FeO, Fe2O3, Fe3O4, MnO2, or any combination thereof.

11. A process for manufacturing a multi-layer pipe article for removing contaminants from a liquid or gas fluid flowing through and within the multi-layer pipe article comprising the steps of:
providing a substrate pipe member;
providing the contaminant capturing liner as claimed in claim 1 on the substrate pipe member; and
removing a gloss layer of the contaminant capturing liner.
